(19) United States
(12) Patent Application Publication
(10) Pub. No.: US 2010/0062863 A1
(43) Pub. Date: Mar. 11, 2010

(54) Apparatus and Method for Gaming System and Game Controller Maintenance

(76) Inventor: Urban Bergant, Kamnik (SI)

Correspondence Address: MCANDREWS HELD & MALLOY, LTD, 500 WEST MADISON STREET, SUITE 3400, CHICAGO, IL, 60661, US

(21) Appl. No.: 12/437,302

(22) Filed: May 7, 2009

(30) Foreign Application Priority Data
Jul. 5, 2008 (AU) 2008902234

(51) Int. Cl. A63F 13/02; G06F 19/00

(52) U.S. Cl. 463/47; 463/40; 463/43

(57) ABSTRACT

A gaming system service apparatus comprising: a memory for storing update data for at least one gaming system, wherein the update data includes one or more game programs or sets of game rules; a data communication interface; a programmer adapted to update a game controller connected to the apparatus via the data communication interface using the update data; and a service controller adapted control the programmer's updating of game data in accordance with service rules and service instructions.

### RELATED APPLICATIONS

This application claims priority to Australia Patent Application No. 2008902234 having a filing date of Jul. 5, 2008, which is incorporated herein by reference in its entirety.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

The present invention relates to maintenance of gaming systems and game controllers.

Game systems having single or multiple player terminals are known. Game controllers for game systems may implement game play processes using a processor executing software and firmware, use programmable hardware or combinations thereof. Gaming industry regulations impose strict control on service activities for such game systems and game controllers, such as routine maintenance and updating.

There is a need for alternative ways to perform updating and service activities for such game systems and game controllers.

### BRIEF SUMMARY OF THE INVENTION

According to one aspect there is provided a gaming system service apparatus comprising:

a memory for storing update data for at least one gaming system, wherein the update data includes one or more game programs or sets of game rules;

a data communication interface;

a programmer adapted to update a game controller connected to the apparatus via the data communication interface using the update data; and

a service controller adapted control the programmer's updating of game data in accordance with service rules and service instructions.

In an embodiment update data can be received via the communication interface and stored in the service apparatus memory.

The service rules and service instructions can be stored in the service apparatus memory.

In an embodiment the service apparatus is provided with a user interface whereby a user can input service instructions to the service controller. The user interface can include a display.

In an embodiment the service controller is further adapted to monitor each service activity performed using the device and record service activity data in a service log in the service apparatus memory.

The service controller can be further adapted to update a service credit balance value and each service activity is associated with a defined credit value, which the service controller deducts from the service credit balance when the activity is performed, and performance of a service activity is inhibited by the service controller if the credit balance value is less than the service activity's associated credit value.

Service activities can include updating data of a game controller, reading status data from a game controller, updating game controller license data and storing update and license data in the service apparatus memory.

In an embodiment updating data of a game controller includes programming a microcontroller, microprocessor or programmable logic device of a game controller with set of instructions and data constituting a game program for execution to implement game play.

In another embodiment updating data of a game controller includes storing a set of computer readable instructions constituting a game program in game controller memory for execution of the instructions by a game controller processor to implement game play.

In another embodiment updating data of a game controller includes storing data constituting a set of game rules in game controller memory.

An embodiment of the service apparatus further comprises a license generator adapted to generate a license associated with a game program, wherein execution of the game program by a game controller is inhibited without access to the license by the game controller. The service apparatus can be further adapted to store the generated license to a license dongle connected via the communication interface, such that when the license dongle is connected to a game controller the license can be accessed by the game controller from the license dongle to allow execution of the game program associated with the license.

In an embodiment of the service apparatus the programmer includes one or more of a set of instructions to drive a programmable logic controller programming circuit; a set of instructions to drive a microcontroller programming circuit; and a set of instructions to drive a read only memory (ROM) programming circuit.

According to another aspect there is provided a method of programming a game controller comprising:

providing a gaming system service apparatus having a data communication interface, a memory storing update data and a programmer;

connecting the gaming system service apparatus to a game controller via the data communication interface;

programming the connected game controller using the stored update data;

monitoring each service activity performed; and

recording service activity data in a service log.

Each service activity can be associated with a defined credit value, and the method further comprise for each service activity to be performed the steps of:

reading a stored credit balance value;

performing the service activity if the stored credit balance value is greater than the service activity's associated credit value; and

updating a service credit balance value by deducting the service activity's associated credit value from the service credit balance,

whereby performance of a service activity is inhibited if the credit balance value is less than the service activity's associated credit value.

An embodiment of the method further comprises the steps of:

downloading update data and service data to the gaming system service apparatus via the data communication interface; and

storing the update data and service data in the service apparatus memory.

The method can further include the step of transferring service activity data to a central service activity log.

According to another aspect there is provided a gaming system service system comprising:

at least one gaming system service apparatus having a data communication interface, a memory, and a programmer for updating data of a game controller connected to the apparatus via the data communication interface;

a network connectable update data server for storing update data; and

a program adapted to mediate downloading of update data from the update data server to a network connected computer executing the program and transfer the update data to a gaming system service apparatus connected to the computer via the communication interface.

In an embodiment of the service system downloading of update data from the update data server is enabled via the program when the gaming system service apparatus is connected to the computer.

A connected gaming system service apparatus can be authenticated before permitting downloading of update data in some embodiments.

The program can be further adapted to read service log data from the memory of the gaming system service apparatus.

An embodiment of the service system further comprises a central service log wherein service log data read from each gaming system service apparatus of the system is stored and wherein the program is adapted to send the read service log data to the central service log.

The service log data can include record data for each service activity performed and service credit data.

In an embodiment the update data server further stores service data and the program is further adapted to mediate downloading of service data from the update data server and transfer of service data to the gaming system service apparatus.

According to another aspect there is provided a program for a gaming system service system comprising a set instructions which when executed by a processor of a network connected computer cause the computer to mediate downloading of update data from an update data server to the computer and transfer the update data to a gaming system service apparatus connected to the computer via a data communication interface.

In an embodiment of the program downloading of update data from the update data server is inhibited when the gaming system service apparatus is not connected to the computer.

### BRIEF DESCRIPTION OF SEVERAL VIEWS OF THE DRAWINGS

An embodiment, incorporating all aspects of the invention, will now be described by way of example only with reference to the accompanying drawings in which

FIG. 1 is a block diagram of the core components of a gaming system;

FIG. 2 is a block diagram of the functional components of a gaming machine;

FIG. 3 is a block diagram representing the structure of a memory;

FIG. 4 is a diagram schematic of a networked gaming system;

FIG. 5a is a block diagram of an embodiment of a gaming system service apparatus;

FIG. 5b is an illustration of an embodiment of a gaming system service apparatus;

FIG. 6 is a detailed block diagram of a gaming system service apparatus connected to a game controller;

FIG. 7 is a flowchart illustrating a service activity procedure;

FIG. 8 is a block diagram of a gaming system service system;

FIG. 9 is a flowchart illustrating procedures executed by the gaming system service system.

### DETAILED DESCRIPTION OF THE INVENTION

Embodiments of the present invention relate to systems, apparatus and methods for performing service activities for gaming systems and game controllers. Embodiments are suitable for use with any gaming system architecture having programmable elements to update programmed data. For example, embodiments may be used for stand alone and distributed architecture gaming systems.

A gaming system can take a number of different forms. In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a game server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

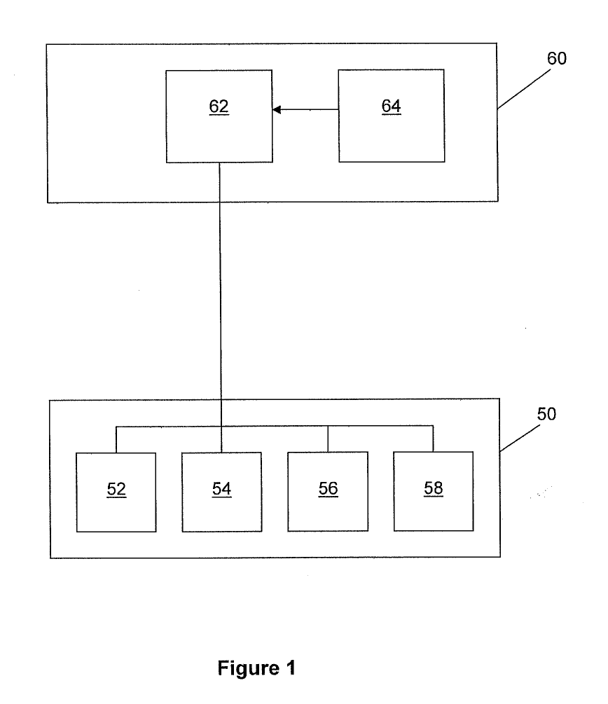

Irrespective of the form, the gaming system comprises several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game and observe the game outcomes.

Components of the player interface may vary from embodiment to embodiment but will typically include a credit mechanism 52 to enable a player to input credits and receive payouts, one or more displays 54 and a game play mechanism 56 that enables a player to input game play instructions (e.g. to place a wager), and one or more speakers 58.

The game controller 60 is in data communication with the player interface and typically includes a processor 62 that processes the game play instructions in accordance with game play rules and outputs game play outcomes to the display. Typically, the game play instructions are stored as program code in a memory 64 but can also be implemented in a programmable logic device or hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

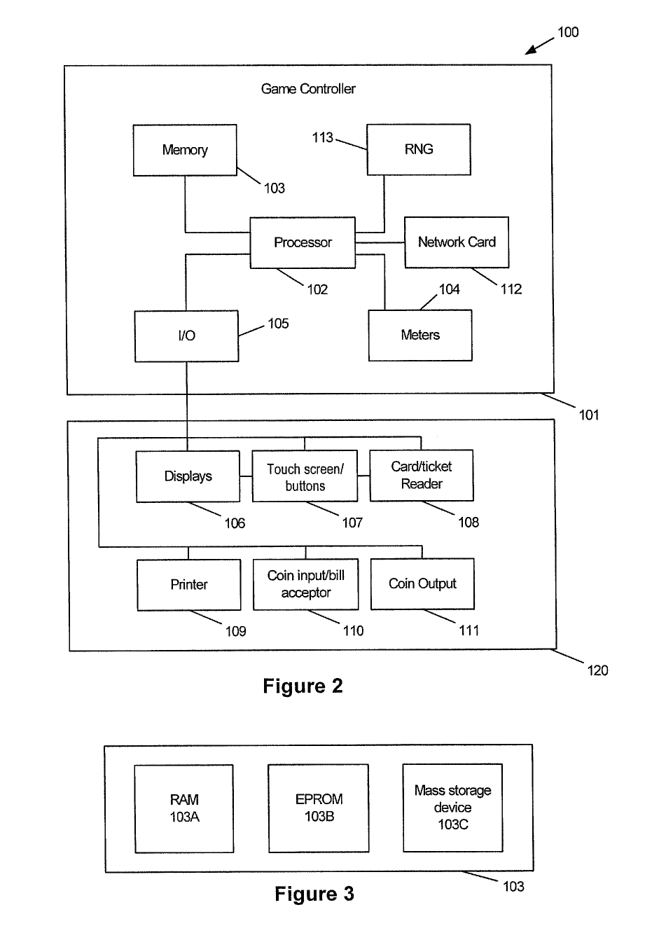

FIG. 2 shows a block diagram of operative components of a typical gaming machine. The gaming system 100 includes a game controller 101 having a processor 102 mounted on a circuit board. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 2, a player interface 120 includes peripheral devices that communicate with the game controller 101 comprise one or more displays 106, a touch screen 107, a card and/or ticket reader 108, a printer 109, a bill acceptor and/or coin input mechanism 110 and a coin output mechanism 111. Additional hardware may be included as part of the gaming system 100, or hardware may be omitted as required for the specific implementation. For example, while buttons or touch screens are typically used in gaming machines to allow a player to place a wager and initiate a play of a game any input device that enables the player to input game play instructions may be used.

In addition, the gaming system 100 may include a communications interface, for example a network card 112. The network card may, for example, send status information, accounting information or other information to a bonus controller, central controller, server or database and receive data or commands from the bonus controller, central controller, server or database. In embodiments employing a player marketing module, communications over a network may be via player marketing module—i.e. the player marketing module may be in data communication with one or more of the above devices and communicate with it on behalf of the gaming machine.

FIG. 3 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

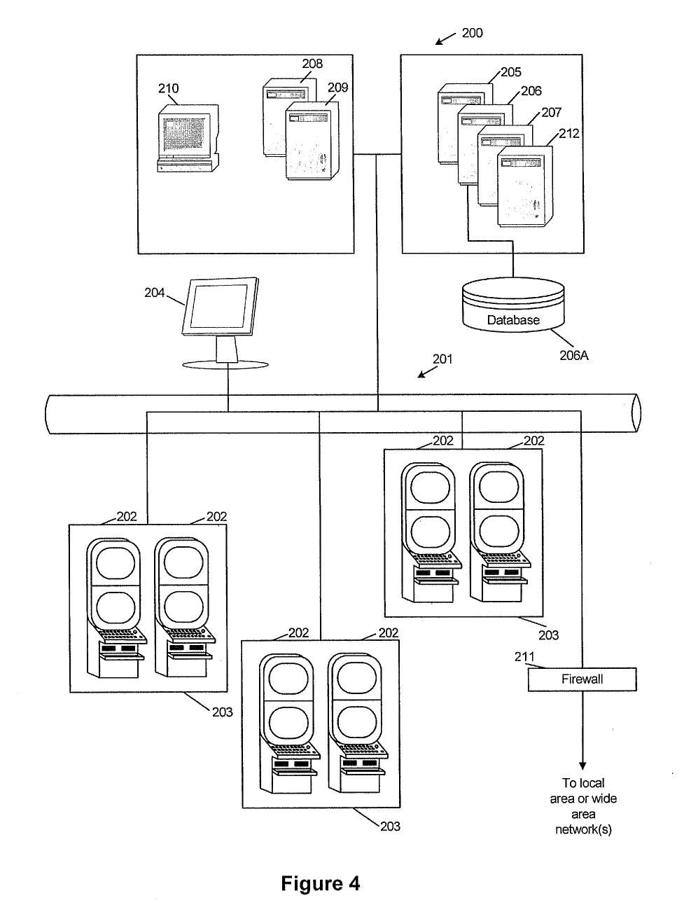

FIG. 4 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 4, are connected to the network 201. The gaming machines 202 provide a player operable interface and may be the same as the gaming machine 100 shown in FIG. 2, or may have simplified functionality depending on the requirements for implementing game play. While banks 203 of two gaming machines are illustrated in FIG. 4, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game. Additional servers 212 may be provided for implementing further functions, such as a loyalty server.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games as required by the terminals.

Irrespective of the game system architecture, gaming industry regulations dictate strict control measures to maintain the integrity of the game system. Maintenance activities such as updating game system components or programs require a service person to access the gaming system which can provide an opportunity for the system to be compromised. Typically only authorized personnel are allowed to access gaming systems for this reason.

An embodiment provides an apparatus for use by a service person to access a gaming system for updating data such as game programs and game rules in a controlled manner. Embodiments of the service apparatus are provided with hardware and software adapted to automatically control the updating of the gaming system to minimize the intervention possible by the service person. This has an advantage of minimizing the opportunity for erroneous or unlawful actions, while also simplifying gaming system servicing activities.

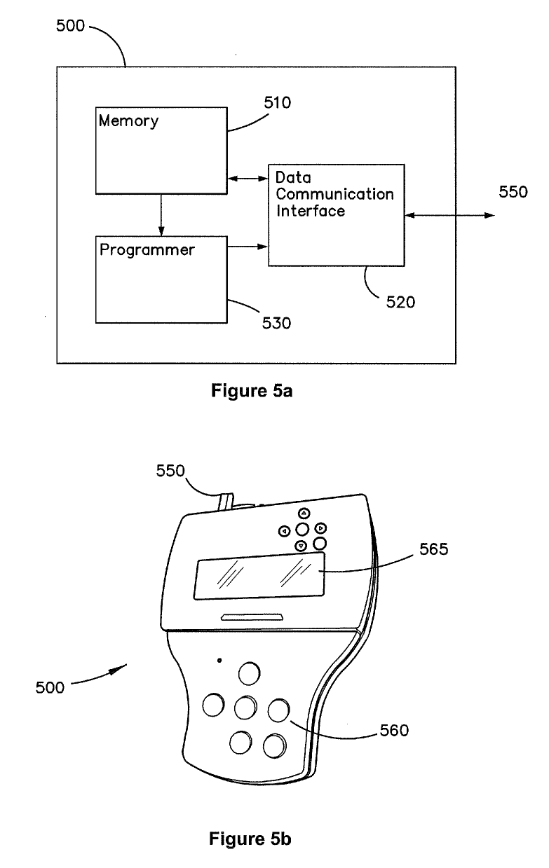

FIG. 5a is a block diagram of an embodiment of a gaming system service apparatus 500 having a memory 510, a data communication interface 520 and a programmer 530. The memory 510 stores update data such as game programs and game rules for loading into a game controller. The memory can include volatile memory such as RAM and non volatile memory such as flash memory devices, hard disk, EPROM etc. For example, the memory can include RAM for temporarily storing data read from gaming device and program files for execution by the programmer 530 along with other related data for updating the gaming device. Programmes for execution by the programmer 530 to update a gaming device along with the game programs and game rules for loading into the gaming device controller can be stored in mass memory such as flash memory or hard disk. In some embodiments parts of the program and data required for execution be the programmer to update a gaming device can be stored in EPROM memory as well as in mass memory or hardcoded/hardwired in the service apparatus 500 hardware. For example, protected aspects of the update program, such as authentication routines and data, may be stored in EPROM or hardwired to minimize the ability to tamper with or otherwise compromise these routines and associated data.

The data communication interface 520 enables a data connection to be made between the service apparatus 500 and other devices, such as a game controller or computer, to enable data communication between the devices. For example, the data communication interface may comprise one or more data ports, for example a USB, parallel or serial data ports and associated communication driver firmware and/or software to control data communication between devices in accordance with compatible communication protocols which may be standard communication protocols known to one skilled in the art or proprietary protocols controlled by a gaming system provider in some embodiments.

The programmer 530 is adapted to update data of a game controller connected to the service apparatus via the data communication interface 520. The programmer 530 comprises a processor adapted to execute programs stored in memory for updating gaming devices. Herein the term “processor” is used to refer generically to any device that can process executable instructions and may include: a microprocessor, microcontroller, programmable logic device or other computational device.

In some embodiments the programmer 530 can also comprise hardware for updating programmable logic devices. For example, a programming circuit for a programmable logic device or other programmable device such as an EPROM used in a game controller may be provided in the service apparatus. The programming circuit can be driven by the programmer 530 when connected to the game controller via the communication interface 520 to program the logic device with update data, such as a game program, read from the service apparatus memory 510. Alternatively programming circuits may be embedded in the game controller and driven by the programmer 530 via the data communication interface 520 to update game data.

In a simple embodiment of the service apparatus 500, update data for one compatible game controller is stored in the memory 510. The update data includes a game program and set of game rules for one game only. When the data communication interface 530 is connected to a game controller the programmer 520 automatically updates the game controller with the stored update data. As there is update data for only one game no user intervention is required to select the game or version of update data to use for programming the game controller. The programmer 520 may be adapted to check that the device is compatible with the game controller before updating, for example by checking version information or hardware configuration.

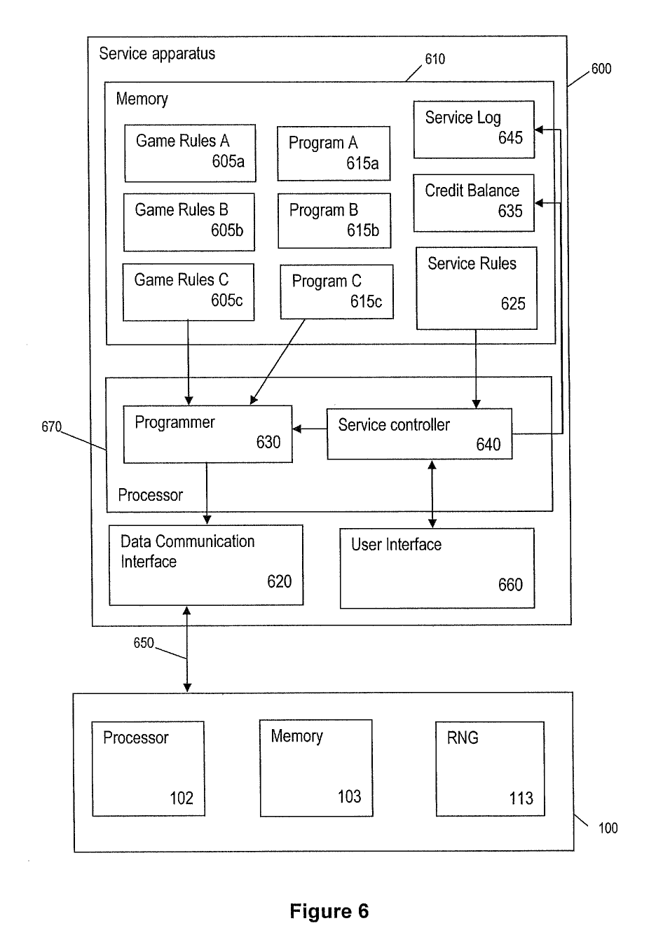

Embodiments of the service apparatus can also be provided with a user interface. For example, as illustrated in FIG. 5b, the service apparatus 500 is provided with buttons 560 to enable a user to input instructions and a display 565 to display information to the user. A block diagram of such an embodiment is illustrated in FIG. 6.

The service apparatus 600 of FIG. 6 has a memory 610, data communication interface 620 and programmer 630 as described above with reference to FIG. 5a. This embodiment includes a service controller 640 and a user interface 660. In the embodiment illustrated the programmer 630 and service controller 640 are both implemented as software modules in a processor 670 of the service apparatus 600.

The service controller 640 is adapted to control the execution of service activities in accordance with service rules and service instructions. Service instructions may be stored in the service device memory as an executable service script or program code, for example when update data is downloaded. Alternatively service instructions may be input by a user via the user interface 660. For example with reference to FIG. 5b, a user may select a set of update data to use for updating a game controller from among a plurality of sets of update data stored in the device memory by scrolling through a menu displayed on the display 565 and selecting items from the menu using appropriate buttons 560. Although in the embodiment illustrated the user interface comprises a display and buttons it should be appreciated that other forms of user interface may be provided, for example a touch screen, keypad or keyboard, mouse or track ball etc and a display may be substituted for or supplemented by indicator lights or sounds in some embodiments. The capabilities of the user interface may be limited to minimize the commands able to be entered by a user as a security measure, to minimize the potential for the service apparatus to be compromised or misused.

The service controller 640 receives the service instructions from the user interface 660 and processes these instructions in accordance with service rules and controls the performance of the service activity. For example, the service instructions input by the user select the service activity of updating a game program of a game controller 100 connected via the data communication interface 620.

The service controller 640 can apply service rules to determine which game program out of a plurality of game programs 615a-c stored in memory 610 is the appropriate game program for the system version of the connected game controller. The service controller 640 then instructs the programmer 630 which game program 615c to use for updating the game controller 100 processor 102 or memory 103.

The programmer 630 reads the appropriate game program 615c from memory 610 and installs the new program on the game controller 100 via the data communication interface 620. On confirmation of successful installation the service controller can then instruct the programmer 630 to update the game controller memory 103 with the appropriate set of game rules 605c.

The steps taken by the programmer 530 630 to update a game controller can vary depending on the game controller architecture. For example where a game controller 100 is implemented primarily using software modules executed on a generic processor 102, updating the data may simply constitute writing a new game program and game rules into the game controller memory 103, for example onto a hard disk or flash memory of a game controller or a game server, such that the new game program and game rules will be used by the processor 102 to execute game play once the update is completed. Any obsolete game programs or game rules can be deleted.

In embodiments where elements of the game controller are implemented using programmable logic devices then the programmer can be adapted to program these devices specifically. Types of programmable logic devices which may be used in a game controller include microprocessors, microcontrollers and programmable hardware such as programmable logic controllers (PLCs) and field programmable gate arrays (FPGAs). Some embodiments of game controllers may use more than one type of programmable device, each implementing a different function. For example a game controller 100 may have a microprocessor 102 for processing game play and a random number generator 113 implemented using a programmable hardware device such as an FPGA. A programming circuit for each programmable logic device used may be embedded in the game controller hardware and driven by the programmer of the connected service apparatus to program the logic device with update data, such as a game program, read from the service apparatus memory. Similarly programming circuits may be embedded in the game controller and driven by the connected service apparatus for programming memory devices, such as electronically programmable read only memory (EPROM), with game rules.

The programmer 530 630 can be implemented as a software module in a processor or using any suitable combination of hardware, firmware and software required for programming game controller components such as microprocessors, microcontrollers, programmable logic controllers, and game controller memory.

The data communication interface 620 enables a data connection 650 to be made between the service apparatus 600 and other devices, such as a game controller or computer. In the embodiment illustrated in FIG. 5b the communication interface includes a data port 550, such as a universal serial bus (USB) port, which enables the service apparatus 500 to be directly connected to a compatible port of game controller in order to program the game controller. However, other types of communications ports or wireless communication technologies are also envisaged to enable data connection between the service apparatus and game controllers or other devices. The data communication interface may include a plurality of ports of the same or differing types for example USB, serial or parallel communication ports, optical fibre connectors etc. The capabilities of the communication interface can be adapted for different embodiments of the service apparatus to be compatible with the gaming systems or game controllers to be serviced using the apparatus.

The service controller 640 can also be adapted to monitor each service activity and store a record of each service activity in memory 610, a set of service records is referred to as a service log 645. The service log 645 includes a record for each service activity. For example, the data recorded for each service activity may include:

the type of service activity, such as a game program update, game rules update, a game system commissioning or decommissioning, license update, reading version information for the connected game controller or game system, game system reset, reading of an error log etc;

time and date of the service activity;

time taken for service activity;

game controller or game system identification;

update data version used for an update;

information regarding whether an update was successful or unsuccessful and any associated error code or details; and

credit information.

The service activity data recorded may vary based on the service activity performed or the embodiment of the system and apparatus implemented.

An embodiment is adapted to limit the use of the service apparatus by means of service credits. In this embodiment each service activity is associated with a defined credit value or a number of credits that it costs the service person to execute the service activity. The service controller 640 stores a service credit balance value and updates the service credit balance value by deducting the credit value associated with each service activity performed. When the service credit balance value is less than the credit value associated with the service activity, performance of the service activity is inhibited. For example, a service apparatus has a credit balance value of five hundred credits stored, updating game rules costs one hundred credits and updating a game program on a microcontroller costs two hundred credits. When the service apparatus is used to update the game program of a game controller two hundred credits are deducted form the service credit balance, leaving a service credit balance value of three hundred credits. The game rules for the game controller are then also updated causing a deduction of a further one hundred credits, leaving a service credit balance value of two hundred credits. If the service person goes to update both the game program and game rules for a further game controller this will costs three hundred credits, which is more than the credit balance value. The service person either needs to obtain further credits or determine whether there is a game controller which only requires an update of either the game rules or the game program to be able to execute a further service activity. The service controller can be adapted to determine whether the credit balance value is sufficient to complete an instructed service activity or set of service activities before beginning execution of the service activity and inhibiting execution of the service activity if the credit balance value is insufficient.

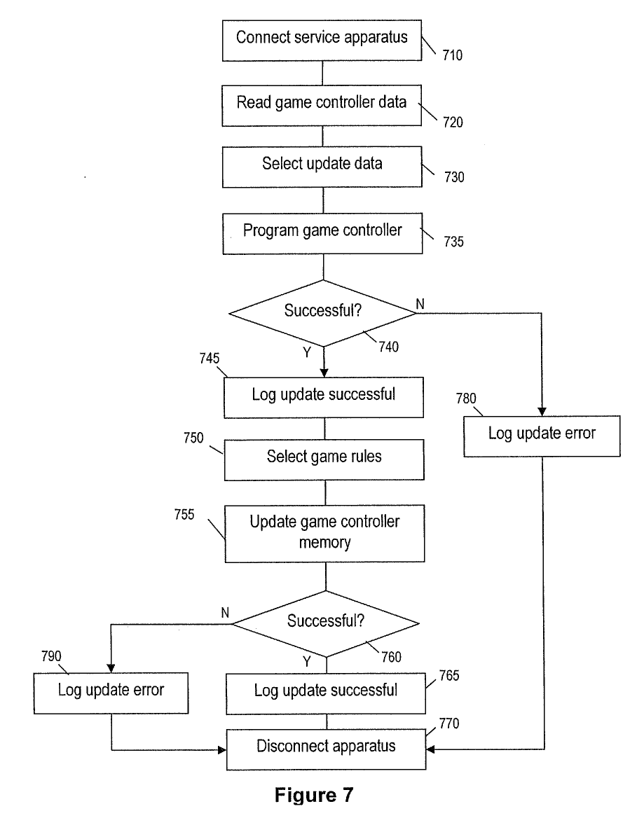

An example of a game controller update process is illustrated in FIG. 7. The service apparatus is connected to the game controller 710 via the data communication interface. The service controller reads data 720 such as software and hardware version information from the game controller. The read game controller data is used to select 730 the update data to use for updating. The selection 730 may also be based on user input, such as selecting whether a new game or a new version of an already installed game is to be loaded into the game controller. The service controller can also determine at this stage whether one or a set of service activities will be required to complete the requested update and determine whether the total credit cost to execute the update, this can take into consideration the credits for both the program and game rule updates. The process proceeds if the stored credit balance value is sufficient to complete the set of service activities. The game controller microcontroller can then be programmed 735 with the selected game program data. If the programming is successful 740 the successful update is logged 745 in the service activity log this can include updating the credit balance value.

The appropriate game rules for the updated program are then selected 750 and stored in the game controller memory 755. Again the set of game rules selected may be based on data read from the game controller as well as the service instructions. If the game controller memory update is successful 760 this is logged 765 and the credit balance value updated to conclude the service activity. The service apparatus can then be disconnected 770. It should be appreciated by a person skilled in the art that other information such as licenses and prize tables could be updated using a similar process.

If the programming is unsuccessful 740 this is recorded in the service activity log 780 and the update discontinued. Similarly if the memory update is unsuccessful 760 this is recorded 790 in the service activity log. Logging of errors may include recording of error codes or any other data which may be used to diagnose the cause of the error. Further steps may also be taken in the case of an unsuccessful update to reverse the update and recover the previous game program and rules.

Alternatively action may be taken to isolate the game controller or take it out of commission due to faulty operation until the game controller can be restored to proper working order. For example, if an update fails due to faulty hardware or because a game system has been compromised in some other way such as by a software virus or hacking then further detailed investigation may be required, beyond the authority and capability of the current service person to deal with. In this situation it may be unlikely or undesirable for the game controller to be restored to normal operation until the root cause of the unsuccessful update is investigated and rectified. Action to isolate or decommission a faulty game controller may be triggered automatically by the service apparatus, for example shutting down the controller, or by intervention by the service person such as physically disconnecting the game controller from a network port.

Additional security measures may also be implemented in embodiments of the service apparatus. For example, special authorization codes may be stored in the service apparatus to enable access to a gaming system and the authorization code may be verified by the gaming system before updating is allowed. A level of access allowed may be dependent on authorization codes. Alternatively different access codes may be used for different gaming systems, which in turn can inhibit the service apparatus being used in an incompatible or unauthorized game system.

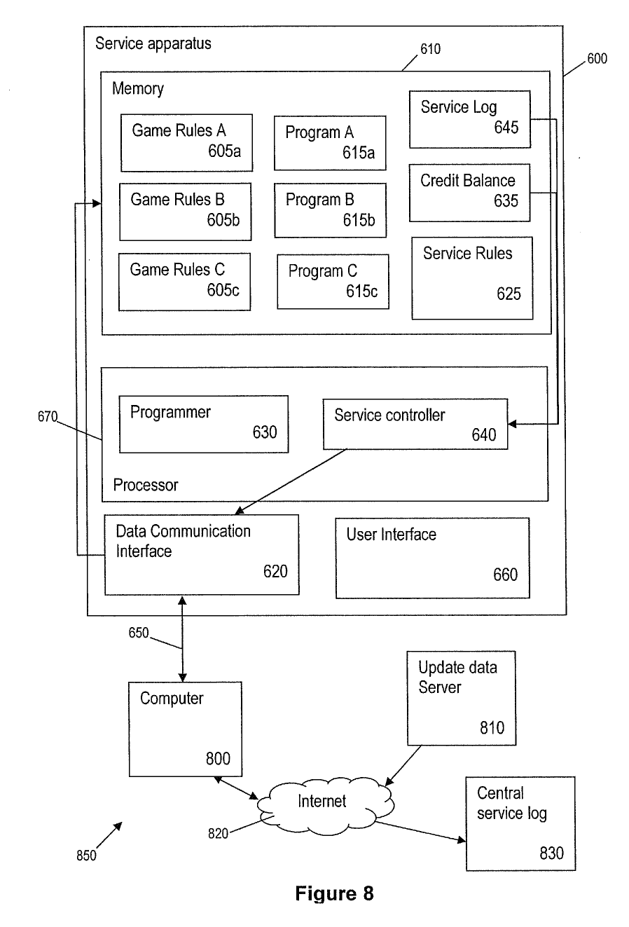

FIG. 8 illustrates the service apparatus of FIG. 6 as part of a gaming system service system 850. The service system 850 comprises at least one service apparatus 600, an update data server 810 and a computer program for installation on a computer 800. The computer program is adapted to mediate downloading of update data via a communication network from the update data server 810 to the computer 800, and transfer of the update data from the computer 800 to the to the service apparatus 600 connected to the computer via the communication interface 620.

In an embodiment the service apparatus 600 must be connected to the computer 800 to enable update data to be downloaded from the update data server 810. For example, the update data server may be accessible via the Internet 820. When the service apparatus 600 is connected to the computer 800 the game data downloading program can be launched. The program may launch automatically when the service apparatus 600 is connected or be opened by the user. The service apparatus is then authenticated before the user can access the update data server, say via a web page, to download update data. Authentication of the service apparatus may be performed by the program reading an identification or authentication code of the service apparatus and sending this code to an authentication server. The authentication server determines whether the code is valid and returns the authentication result to the program.

The authentication server may be the update data server or another server. In the case where the authentication server is the game server, the authentication process may grant access to the update data as a result of a valid authentication. For example, the authentication may constitute a log in procedure to access the update data. In the case where the authentication server is not the update data server the authentication process may return an authentication code or key which can then be used to access the update data server for downloading of update data. Accessing the update data server may be performed automatically by the program in response to successful authentication of the service apparatus. In an alternative embodiment authentication of the apparatus may be performed by the program and an access key, verifiable by the update data server, generated by the program to access the update data server for downloading update data.

In an embodiment of the service system the user can browse update data available for download from the update data server via secure web pages after authentication of the service apparatus. Alternatively the program may provide an interface for selecting from update data available for download, for example using series of menus or a file manager.

Update data can include game programs, sets of game rules, game instructions, game graphics and audio files, outcome and prize tables etc. The downloadable update data can include programs and data for loading into each different processor or memory component of a gaming system to enable a complete new game to be installed for a gaming system using the service apparatus. For example, update data can include game programs and game rules to be downloaded for installation into a game controller processor and memory, game instructions, graphics and audio data can be downloaded for installation in game controller or player terminal memory for presentation of game information and outcomes to a player during game play and a program for adapting a player interface of a player terminal for the game can also be downloaded. Other update data may also be made available for downloading, such as licenses.

Data may also be read from the service apparatus 600 using the program and stored on the computer 800 memory or transmitted to a third party, such as an administrative body or service coordinator via the network 820. For example, the service log 645 may be read from the service apparatus 600 and transmitted as a data file via the network 820 for storing a central service log 830. The central service log 830 may be used for audit and service tracking purposes. The service log 645 stored on the service apparatus may be automatically deleted after the logged data is successfully stored in the central service log 830.

For embodiments where service activity performance is controlled using credits, the remaining credit balance value can also be read from the service apparatus. Additional service credits can be purchased or applied for from a service coordinator using the program. The program and transfer allocated additional credits to the service apparatus 600 and the service controller 630 update the stored credit balance value 635 accordingly.

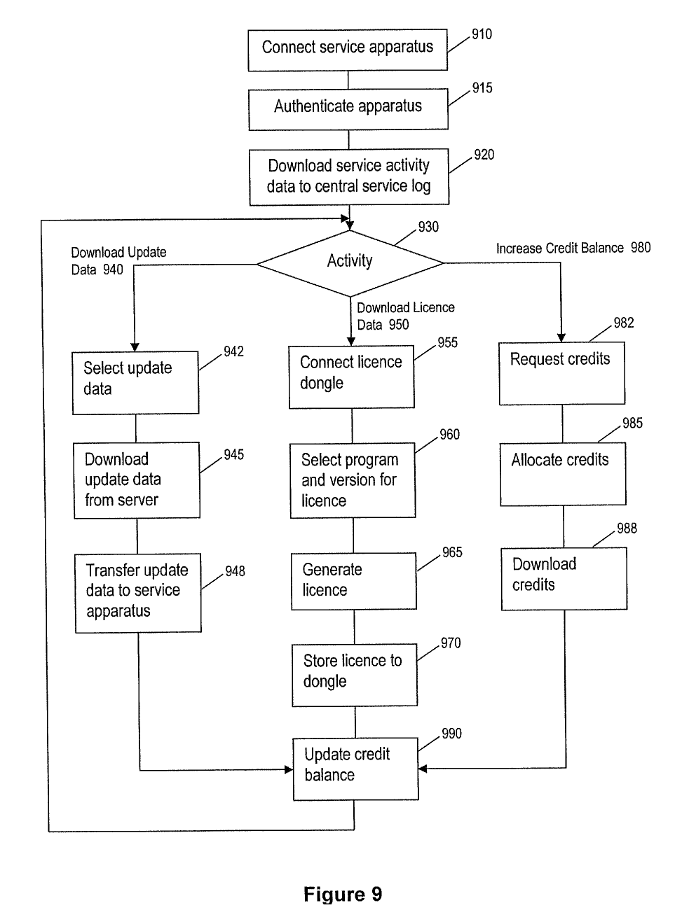

Some examples of procedures for downloading data to the service apparatus using the service system are illustrated in FIG. 9. The service apparatus is connected to the computer 910 and the program launched. The service apparatus is authenticated 915 by an authentication server to enable access to the update data server and other servers such as a central service log server and service credit server. The service activity log can be read and transferred to a central service log 920 automatically on authentication of the service apparatus. The user may then be prompted by the program to choose an activity 930. The activity options illustrated include downloading update data 940, downloading license data 950, and update credit balance 980.

When increase credit balance 980 is selected, the credit balance value of the service apparatus can be displayed and the user makes a request for additional service credits 982. The request 982 may be made to a third party, such as a service coordinator, via the program by filling in a form or using a pick list and may require payment before credits are allocated 985. Alternatively a service person may have a defined credit allocation for a period, for example ten thousand service credits per month, and this credit allocation accumulated in an account accessible via the program. In this instance the service person can simply allocate 985 the credit value to be transferred from their account to the service apparatus. The allocated credits are then downloaded 988 via the program to the service apparatus. The stored credit balance value is updated accordingly 990 by the service controller.

When download update data 940 is selected the program connects to the update data server via the communication network to enable the user to browse the update data available for download. The update data available for downloading can include game programs, game rules and other game data for a plurality of games and a plurality of gaming system versions. The user can select update data for download 942 from amongst this available update data. For example particular games may be requested by a gaming venue operator and the service person can select update data for the versions of these games compatible with the game systems operated at the gaming venue identified to be updated with the requested games. If there is a service credit cost for downloading update data, then whether the stored service credit balance value is sufficient for the download can be verified at this step and the download aborted in the case of insufficient service credits.

During update data selection the service credit costs for installing each set of update data can be determined. Embodiments of the program can be adapted to keep a record of the installation costs to be used to request a credit balance increase after downloading the update data to ensure a sufficient credit balance is stored to enable the requested updated to be completed.

Selected update data is downloaded 945 from the update data server to the computer, and then transferred to the service apparatus 948. The service credit balance is then updated 990 if there is any service credit cost for the download. In an embodiment a credit balance increase for the service credit amount required to complete installation of the update data on game system may be automatically requested or a request initiated by the program on successful download of the update data.

Update data, such as game programs and game rules, may be downloaded and stored to the service apparatus as encrypted files to inhibit any tampering and the encryption can also have the advantage of compressing the files to minimize download time and service apparatus memory requirements. The service apparatus can be adapted to decrypt encrypted update data files as a step in the automatic updating process. Alternatively update data files may be loaded into the game controller in their encrypted form and decrypted by the game controller. Whether update data can be delivered in an encrypted or decrypted form may be dependent on the game controller architecture. For example driving a PLC programming circuit by the service apparatus may necessitate decrypting the program data by the service apparatus.

In an embodiment of the system licenses may be downloaded as part of update data. In an alternative embodiment licenses can be generated using the service apparatus and stored on a license dongle, which can be a memory device such as a USB flash memory device. The license dongle is connectable to a game controller which reads the stored license to enable game play. It is a regulation in some jurisdictions, such as Spain, that only certified version of software programs can be used in gaming systems. Using a license dongle can prohibit uncertified version of software being used by disabling the gaming system unless a license dongle having a valid license for the certified software version stored thereon is connected.

An example of a process for generating a license is illustrated in FIG. 9 when the download license data 950 activity is selected. The license dongle is connected to the computer as well as the already connected service apparatus 955. The program can then enable access to a license server via the network. Information regarding programs and versions for which license data can be downloaded can be displayed for the user via a web page or menu interface. The user selects 960 the program and version for which a license is to be generated and downloads the license information. The required license is then generated 965 and stored on the license dongle 970. The credit balance can be updated 990 in accordance with any credit cost associated with downloading the license data and generating the license.

In an embodiment the license is generated by a license generator of the connected gaming system service apparatus. In this embodiment the downloaded license data is transferred to the service apparatus which uses this to generate the appropriate license. For example the license generator may encrypt the program version data into a license file using an encryption algorithm embedded in the service device hardware or firmware. Data such as a license identifier or authorization code may also be included in the license file. The license file is then stored on the license dongle via the computer. The license file can be read and the validity of the license verified by a gaming system when the license dongle is connected. Using the service apparatus to generate the license can have security advantages over providing a license generator as part of the computer program as it is more difficult to work out the encryption process or hack into a license generator executing on the service apparatus compared to a program subroutine executing on a computer.

Security concerns can be mitigated by providing the majority of the control and processing functionality for generation of licenses and performance of service activities embedded in the service apparatus.

To minimize the risk of inappropriate updating of gaming system data or programs, it is desirable for the access that the service person has to manipulate the system to be limited to a specified activity or set of activities. This access restriction can be provided with embodiments of the service system and service apparatus. It is also desirable to enable a third party to monitor the service activities performed via automatic service activity logging.

Servicing of gaming systems and updating of any updatable programs or data is an activity during which a gaming system can be vulnerable to illicit or erroneous manipulation. This can, in turn, cause problems for the gaming operator, patrons and service personnel. Embodiments of the servicing apparatus, system and method described herein reduce the risk of errors by minimizing the operator input required for servicing gaming systems in conjunction with monitoring service activities undertaken.

It will be appreciated that embodiments of the service apparatus and service system can be adapted to update programs, graphics and audio data of player interfaces for multi terminal gaming systems or networked gaming systems as well as game controllers and stand alone gaming systems.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in any country.

1. A gaming system service apparatus comprising:
a memory for storing update data for at least one gaming system, wherein the update data includes one or more game programs or sets of game rules;
a data communication interface;
a programmer adapted to update a game controller connected to the apparatus via the data communication interface using the update data; and
a service controller adapted control the programmer's updating of game data in accordance with service rules and service instructions.

2. A service apparatus as claimed in claim 1 wherein update data is received via the communication interface and stored in the service apparatus memory.

3. A service apparatus as claimed in claim 1 wherein the service rules and service instructions are stored in the service apparatus memory.

4. A service apparatus as claimed in claim 1 further comprising a user interface whereby a user can input service instructions to the service controller.

5. A service apparatus as claimed in claim 4 wherein the user interface includes a display.

6. A service apparatus as claimed in claim 1 wherein the service controller is further adapted to monitor each service activity performed using the device and record service activity data in a service log in the service apparatus memory.

7. A service apparatus as claimed in claim 6 wherein the service controller is further adapted to update a service credit balance value and each service activity is associated with a defined credit value, which the service controller deducts from the service credit balance when the activity is performed, and performance of a service activity is inhibited by the service controller if the credit balance value is less than the service activity's associated credit value.

8. A service apparatus as claimed in claim 6 wherein service activities include updating data of a game controller, reading status data from a game controller, updating game controller license data and storing update and license data in the service apparatus memory.

9. A service apparatus as claimed in claim 1 wherein updating data of a game controller includes programming a microcontroller, microprocessor or programmable logic device of a game controller with set of instructions and data constituting a game program for execution to implement game play.

10. A service apparatus as claimed in claim 1 wherein updating data of a game controller includes storing a set of computer readable instructions constituting a game program in game controller memory for execution of the instructions by a game controller processor to implement game play.

11. A service apparatus as claimed in claim 1 wherein updating data of a game controller includes storing data constituting a set of game rules in game controller memory.

12. A service apparatus as claimed in claim 1 further comprising a license generator adapted to generate a license associated with a game program, wherein execution of the game program by a game controller is inhibited without access to the license by the game controller.

13. A service apparatus as claimed in claim 12 further adapted to store the generated license to a license dongle connected via the communication interface, such that when the license dongle is connected to a game controller the license can be accessed by the game controller from the license dongle to allow execution of the game program associated with the license.

14. A service apparatus as claimed in claim 1 wherein the programmer includes one or more of a set of instructions to drive a programmable logic controller programming circuit; a set of instructions to drive a microcontroller programming circuit; and a set of instructions to drive a read only memory (ROM) programming circuit.

15. A method of programming a game controller comprising:
providing a gaming system service apparatus having a data communication interface, a memory storing update data and a programmer;
connecting the gaming system service apparatus to a game controller via the data communication interface;
programming the connected game controller using the stored update data;
monitoring each service activity performed; and
recording service activity data in a service log.

16. A method of programming a game controller as claimed in claim 15 wherein each service activity is associated with a defined credit value, the method further comprising for each service activity to be performed:
reading a stored credit balance value;
performing the service activity if the stored credit balance value is greater than the service activity's associated credit value; and
updating a service credit balance value by deducting the service activity's associated credit value from the service credit balance,
whereby performance of a service activity is inhibited if the credit balance value is less than the service activity's associated credit value.

17. A method of programming a game controller as claimed in claim 15 wherein service activities include updating data of a game controller, reading status data from a game controller, updating game controller license data and storing update data or license data in the service apparatus memory.

18. A method of programming a game controller as claimed in claim 15 further comprising
downloading update data and service data to the gaming system service apparatus via the data communication interface; and
storing the update data and service data in the service apparatus memory.

19. A method of programming a game controller as claimed in claim 18 further comprising transferring service activity data to a central service activity log.

20. A gaming system service system comprising:
at least one gaming system service apparatus having a data communication interface, a memory, and a programmer for updating data of a game controller connected to the apparatus via the data communication interface;
a network connectable update data server for storing update data; and
a program adapted to mediate downloading of update data from the update data server to a network connected computer executing the program and transfer the update data to a gaming system service apparatus connected to the computer via the communication interface.

21. A service system as claimed in claim 20 wherein downloading of update data from the update data server is enabled via the program when the gaming system service apparatus is connected to the computer.

22. A service system as claimed in claim 20 wherein the connected gaming system service apparatus is authenticated before permitting downloading of update data.

23. A service system as claimed in claim 20 wherein update data includes one or more of game programs and sets of game rules.

24. A service system as claimed in claim 20 wherein the program is further adapted to read service log data from the memory of the gaming system service apparatus.

25. A service system as claimed in claim 24 further comprising a central service log wherein service log data read from each gaming system service apparatus of the system is stored and wherein the program is adapted to send the read service log data to the central service log.

26. A service system as claimed in claim 24 wherein the service log data includes record data for each service activity performed and service credit data.

27. A service system as claimed in claim 20 wherein the update data server further stores service data and the program is further adapted to mediate downloading of service data from the update data server and transfer of service data to the gaming system service apparatus.

28. A service system as claimed in claim 27 wherein service data includes service rules, service instructions and service credit data.

29. A program for a game system service system comprising a set instructions which when executed by a processor of a network connected computer cause the computer to mediate downloading of update data from an update data server to the computer and transfer the update data to a gaming system service apparatus connected to the computer via a data communication interface.

30. A program as claimed in claim 29 wherein downloading of update data from the update data server is inhibited when the gaming system service apparatus is not connected to the computer.
